(19) United States
(12) Patent Application Publication
(10) Pub. No.: US 2022/0227330 A1
(43) Pub. Date: Jul. 21, 2022

(54) Child Vehicle Seat Tether Extension and Method

(71) Applicant: James Klugo, Clemson, SC (US)

(72) Inventor: James Klugo, Clemson, SC (US)

(21) Appl. No.: 17/151,357

(22) Filed: Jan. 18, 2021

(51) Int. Cl. B60R 22/10; B60R 22/26; B60R 22/30; B60N 2/28

(52) U.S. Cl. CPC B60R 22/105; B60R 22/26; B60N 2002/2815; B60N 2/2803; B60R 22/30

(57) ABSTRACT

A child vehicle seat tether extension apparatus includes a main body member having a first end and a second end, wherein clips or other attachment means are disposed on both ends thereof. The clip on the first end is attached to the anchor point in the rear seat of a vehicle, and the clip on the second end is attached to a tether that is connected to the child safety seat. Optionally, the tether extension apparatus may be adjustable. The main body member of the tether extension apparatus may be made of either a rigid material or a flexible material, such as strap. The attachment means may be any suitable type of clip, carabiner, hook or similar mechanism for securing the tether extension to an anchor point in a vehicle at one end, and the tether of a child's safely seat on the other end thereof.

### BACKGROUND OF THE INVENTION

The present invention relates generally to anchoring assemblies for securing a child's car seat within a vehicle. More specifically, the present invention relates to an extender that may be attached at one end to an anchor point in a vehicle, and further, that attaches at a second end to a tether that is connected to a child's car seat.

Nearly every parent of infants and small children in the modern world has experienced the difficulty and frustration of securing a child's safety seat to a vehicle. Oftentimes, children's car seats are moved from one vehicle to another, and the process is time consuming and stressful. Late model vehicles typically include one or more anchor points, such as a bracket, a fixed D-ring, or the like, in the rear seats of automobiles. These anchor points are usually positioned between the backrest and the seat portion, and are only accessible by sliding a user's hand into the crack therebetween to clip a tether thereto. Most child safety seats include an anchor assembly, such as a tether, that may be affixed to the anchor point to secure the child safety seat within the rear seat of the automobile so that the child safety seat remains securely in place while driving, and particularly in the event of an automobile accident.

It would be desirable to provide a tethering system that allows a child safety seat to be secured within a vehicle without having to reach between the seat and the backrest with a tether clip in order to gain access to the anchor point on a vehicle. Many different types of anchoring systems have been developed in an effort to make child car seats easier to install in a vehicle, while providing additional safety to a child seated therein while the vehicle is underway. The following references disclose a variety of different child safety seats with tethers or other types of anchoring assemblies, and these references are incorporated herein by reference, in their entireties:

U.S. Pat. No. 4,768,828 Structure for Fixing Children's Seats in Cars

A structure for fixing a child's seat body on a car seat by means of a car seat belt wherein hook members are provided on both sides of the child's seat body and the pulling end of the seat belt is connected to the hook members through connectors which are hooked upon the hook members.

U.S. Pat. No. 5,630,645 Safety Seat Tether Strap

A safety seat 10, for use in a vehicle, where the safely seat 10 comprises a seat portion 19a, a backrest 19 having a head end remote from the seat portion 19a, a first and second mutually spaced anchorage locations 13 and 15a on the head end of the backrest 19, a connector 12 for engagement with a securement point on a vehicle, the connector 12 having a strap opening, a tether strap 11 extending in a loop from the first anchorage location 15, through the strap opening of the connector 12, to a second anchorage location 15a, and a length adjustor 13 or 13a for adjusting the length of the tether strap 11 loop. This provides a tether strap 11 suitable for use with the safety seat 10 in either a rear or forward facing position. Another significant advantage is having the adjuster 13 of 13a in line with the tether strap 11 to significantly reduce the effective length between the backrest 19 and the securement point on the vehicle.

U.S. Pat. No. 6,193,310 Child Car Seat Adapted for Frontward and Rearward Facing Configurations

A child car seat is configured for attachment to vehicle anchor points in at least two configurations including a frontward facing configuration and a rearward facing configuration. The child car seat includes an exterior portion and an interior portion, the interior portion defining a receiving area for a child. A front area of the interior portion is generally open and a rear area of the interior portion is generally closed by a back section. A first structure is positioned on the interior portion for securing a first strap thereto such that the first strap is positioned interiorly of the seat and is capable of extending both toward the front area and the rear area, and a second structure is positioned on the interior portion for securing a second strap thereto such that the second strap is positioned interiorly of the seat and is capable of facing both toward the front area and the rear area.

U.S. Pat. No. 6,416,129 Child Seat Anchoring Structure

A child seat anchoring structure is provided that can prevent the seat belt webbing from getting caught in the components that secure the child seat to the vehicle. The child seat anchoring structure has child seat attachment part in which a child seat is installed by moving a locking part of the child seat from the forward direction of the vehicle so that the locking part approaches the rod-shaped attachment part of a child seat fixing striker that is mounted close to a seat belt anchor to which the webbing is fixed. The structure is provided with a webbing guide bar part that prevents the webbing from entering the region between the rod-shaped attachment part and the locking part of the child seat.

U.S. Pat. No. 6,592,183 Vehicle Anchor System for Juvenile Vehicle Seat

A juvenile seat assembly is provided for use with a vehicle seat. The assembly includes a juvenile seat for placement on the vehicle seal and a vehicle anchor system coupled to the seat. The juvenile seat includes a first pair of openings and a second pair of openings. The vehicle anchor system includes an anchor belt adapted to be coupled to a pair of anchor mounts provided in or near the vehicle seat. The anchor belt includes a strap having a central portion and opposite end portions, and a connector coupled to each end portion and adapted to be coupled to one of the anchor mounts. The anchor belt is threaded through the first openings to position the seal in a first, rearwardly facing position and the anchor belt is threaded through the second openings to position the seat in a second, forwardly facing position. The vehicle anchor system also includes a leash coupled to the juvenile seat and to the central portion of the anchor belt. The leash remains coupled to the seat and to the anchor belt when the anchor belt is moved between the first and second openings of the seat.

U.S. Pat. No. 6,948,218 Latch System for Child Seat

A latch system for attaching a child seat to an anchorage of a vehicle seat includes a first latch device connected to a first end of a length of webbing, an adjuster connected to a second end of the length of webbing, and a second latch device. The adjuster has a plate member extending from one end, and the plate member has a connection opening formed therein. The second latch device includes a main member having a hook formed at a first end and a connection aperture at a second end that is distal from the first end. A portion of the second end of the main member passes through the connection opening, and a portion of the plate member passes through the connection aperture.

U.S. Pat. No. 7,044,548 Child Vehicle Seat Having Permanently Attached Latch System

A latch system adapted for use with a child vehicle seat has a securing belt, latches which are disposed at each end of the securing belt, and a connection member. The latches are adapted for connection to anchor points rigidly connected to the vehicle. The connection member has a loop portion through which the securing belt is slidably disposed and a connection portion adapted for permanent connection to the child vehicle seat.

U.S. Pat. No. 7,591,510 Highly Adjustable Safety Beit for Child Restraint

A seatbelt for a child in a child seat provides a broad range of adjustment by configuring a belt to be threaded through an adjustment cleat with a loose end. The seatbelt adjustment range can be increased by supplying adjustments on two sides of a claspable belt. A sleeve surrounds a portion of the belt to reduce the size of any free loops. The seatbelt retainers can be placed close to one another so that a snug fit for the child in the child seat can be obtained with the seatbelt. The seatbelt configuration provides a secure, simple to manipulate adjustment mechanism that fits a wide range of children for a variety of child seats.

U.S. Pat. No. 8,801,097 Anchor System for Juvenile Vehicle Seat

A juvenile seat assembly is provided for use with a vehicle seat. The assembly includes a juvenile seat for placement on the vehicle seat and a vehicle anchor system. The vehicle anchor system includes an anchor belt adapted to be coupled to a pair of anchor mounts provided in or near the vehicle seat. The anchor belt includes a strap and connectors coupled to the strap and defining a central portion, the connectors adapted to be coupled to one of the anchor mounts.

U.S. Pat. No. 9,150,126 Anchor Latch Assembly for Child Restraint System

A child safety seat has a seat shell with a seat back portion, a seat, bottom portion, and a seating surface. A track is provided on the child safety seat. A slot has a slot length along the track and a slot width defined between two parts of the track. An anchor strap has a belt, two anchoring connectors coupled to and spaced apart along the belt, and a central section between the two anchoring connectors. The central section has a thickness less than the slot width and captured in the slot between the two parts of the track. The two anchoring connectors are sized larger than the slot width thereby preventing removal of the anchor strap from the child safety seat. The anchor strap can slide along the slot length between at least a forward facing anchor position and a rear facing anchor position on the seat shell.

U.S. Pat. No. 5,941,601 Child Seat Anchorage

A motor vehicle passenger seat includes a seat, a seat-back in contacting relationship with the seat, and a pair of laterally spaced anchorage members for anchoring a child seat disposed at the point of contact between the seat and seat-back, the anchorage members are pivotally mounted in relation to the seat whereby the anchorage members can be pivoted between a use position in which they are upwardly disposed through a gap between the seat and the seat-back so that a child seat can be secured thereto, and a stowage position in which the anchorage members are downwardly disposed through the gap and hidden from view thereby, the anchorage members being constrained to pivot in opposite directions to one another when moving between the use and stowage positions.

U.S. Pat. No. 6,030,046 Apparatus for Anchoring a Child Sear within a Motor Vehicle

An apparatus for anchoring a child seat within a motor vehicle includes an anchorage bar having a pair of child seat connector portions located at the seat bight of a seating unit for a motor vehicle. The seat connection portions are carried by an anchorage bar which is pivotally interconnected to mounting brackets which connect a seat back of the vehicle seat to the floor pan. The anchorage bar is upwardly pivoted.

U.S. Pat. No. 6,962,394 Restraint Coupling

A coupling to attach a device such as an infant seat to an anchor member. One version of the coupling is characterized by a frame having a mouth with a seat configured to receive the anchor member and a lever movably mounted on the frame to hold the anchor member inside the mouth. The lever has a downwardly projecting finger that blocks the mouth of the notch in the closed position and allows access to the notch when moved to the open position. The coupling may include a stop member to resist movement from the closed to the open position. The coupling also may include a web adjuster or other connecting device operatively disposed between the coupling and the device.

U.S. Pat. No. 7,278,684 Retractable Coupling Apparatus

An apparatus and method for mounting an add-on passenger restraint system to a vehicle seat is provided. The apparatus comprises a retractor affixed to the add-on passenger restraint system. An extension member extends between the retractor and a coupling member. The coupling member is configured to engage an anchorage attached to the vehicle.

### U.S. Application No. 20070284924 Fitting for Child Safety Seat

There is provided a fitting for a child safety seat for use with a vehicle seat comprising a body; provided to said body, a first connector for connecting to an anchorage of a child safety seat; and provided to the body and spaced from the first connector, a second connector for connecting to an anchorage of a vehicle seat. There is also provided a child safety seat for use with a vehicle seat comprising a base arranged for secure fitting to said vehicle seat; a child seat arranged for secure placement of a child therein; and a mounting for mounting said child seat to said base, wherein said base is provided with an anchorage for connecting a connector of a fitting thereto. The child safety seat and fitting may comprise a kit of parts.

### U.S. Application No. 20090250946 Multi-Pivot Latch Assemblies

Latch assemblies for releasably engaging anchor members and other attachment points in vehicles are disclosed herein. A multi-pivot latch assembly configured in accordance with one embodiment of the disclosure includes a latch and an ejector movably coupled to a frame, in some embodiments, a biasing member holds the latch in a first or open position prior to attachment to an anchor member. When the anchor member presses against the ejector, the latch pivots from the first or open position to a second position about a first pivot point, and then from the second position to a third or fully closed position about a second pivot point.

### U.S. Application No. 20100033001 Single Retractor Lower Anchor Connection System

A lower anchor connection system for securing the child seat to vehicle anchor bites. A single retractor includes a web extendable therefrom connected to a strap having at its opposite ends couplings for lockingly engaging the anchor bights. A release button on the retractor when depressed allows the retractor web to be withdrawn holding the couplings adjacent the child seat in a stored position.

### U.S. Application No. 20040051355 Security Strap System

A connecting system for a child car seat (3) of a type which can either be rearward or forward facing. Separate strap paths (7,8) are associated with the seat for each of the rearward and facing positions of the child car seat. The connecting system has a connecting strap (6) with latches (14) at either end adapted to engage with latching bars on the vehicle. The connecting strap (6) is fixed into a strap path (7,8) and is sufficiently long so that it can be passed through the front path (8) from opposite sides to cross and to extend out the opposite side of the front path for use when the child car seat is in the rearward facing position or be passed through the rear path (7) from opposite sides to cross and to extend out the opposite side of the rear path for use when the child car seat is in the forward facing position.

### U.S. Application No. 20040100112 Anchor Arrangement for Securing an Infant Seat

A vehicle cabin is provided, the cabin including at least one passenger seat and an anchor arrangement configured to detachably couple to a rearwardly facing infant seat situated on the passenger seat, in which the anchor arrangement prevents the rearwardly facing infant seat from accelerating toward a rear of a vehicle.

### U.S. Application No. 20070194590 Tether Routing Apparatus and Method of Using Same

A child seat mounting arrangement includes a frame member of a vehicle having an inner surface and an outer surface. A base plate has an engaging surface and an opposite surface. The engaging surface is fixedly secured to the frame member inner surface. A rigid rod is fixedly secured to the base plate opposite surface and extends beyond the frame member such that an engaging portion of the rigid rod is spaced apart from the frame member outer surface and is adapted to receive a tether of a child seat therearound.

### U.S. Application No. 20090224595 Seat Belt Extension Device

The present invention provides a resilient seat belt extension device comprising: a female receptacle adapted to engage a seat belt system's male buckle; a male buckle adapted to engage a seat belt system's female receptacle; and a resilient connector fixedly attached to the female receptacle on one end and the male buckle on another end; wherein the connector is formed by the following steps: (i) attaching ends of an elongated material together to form the connector with two layers of elongated material; (ii) placing a non-liquid compound between the two layers of elongated material wherein the compound is adapted to provide resiliency to the connector; (iii) attaching the two layers of elongated material together; and (iv) curing the compound at a predetermined temperature. The present invention also provides a method of making the above-described device.

### U.S. Application No. 20110057489 Infant Car Seat System and Strap

An infant seat system is shown and described. In one embodiment the system includes an infant car seat (ICS) having a strap-interface; a strap interfaced with the ICS; a clip attached to strap; and a ratchet tightener (RT) positioned in between the clip and the infant seat for tightening the strap and securing the ICS quickly and easily.

AU Application No. 2008100765 a Child Safety Seat Having a Tether Strap with Connection Means

A child safety seat arrangement is disclosed wherein the child 31 is secured to the safety seat 30 by a harness 20. The harness 20 is then secured with respect to the vehicle by a mounting arrangement that is independent of the safety seat 30. The harness 20 preferably includes two shoulder straps 21 which are looped behind the safety seat 30. Preferably, there is also a safety seat 30 that is itself secured with respect to the vehicle via a tether strap 40. The harness 20 and tether strap 40 may be connected to a single vehicle tether point 50 through common connection components.

### BRIEF SUMMARY OF THE INVENTION

In accordance with one aspect of the invention, a first embodiment of a child vehicle seat tether extension apparatus includes a strap having a first end and a second end, wherein clips or other attachment means are disposed on both ends thereof. The clip on the first end is attached to the anchor point in the rear seat of a vehicle, and the clip on the second end is attached to a tether that is connected to the child safety seat. Optionally, the tether extension apparatus may be adjustable, although the tether systems that come standard on most child safety seats are typically themselves adjustable or tightenable, so that an additional adjustment means attached to the tether extension apparatus may be unnecessary.

In a second embodiment, the tether extension apparatus may be made of a rigid material, rather than a strap. The attachment means may be any suitable type of clip, carabiner, hook or similar mechanism for securing the tether extension to an anchor point in a vehicle at one end, and the tether of a child's safety seat on the other end thereof. The rigid material may comprise metal, plastic, or any other kind of rigid material that is strong enough to maintain a secure connection between the anchor point of a vehicle and a child safety seat tether.

When not in use, the tether extension apparatus may extend from the anchor point in the vehicle outwardly between the backrest and the seat cushion of the vehicle seat, so that it is clearly visible to a user, and is easily accessible for attachment to a child's safety seat tether. Alternatively, the tether extension apparatus be attached directly to the child safety seat in one embodiment, rather than being attached to a tether.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of two child vehicle seat tether extensions shown attached to respective anchor points in a vehicle seat for securing the child vehicle seat to the vehicle;

FIG. 2 is a perspective view of one embodiment of a pair of child vehicle seat tether extension shown attached to respective anchor points in a vehicle seat;

FIG. 3 is a perspective view of one embodiment of a child vehicle seat tether extension, including a clip attached to one end of a strap, and a ring attached to the other end of the strap;

FIG. 4 is a perspective view of another embodiment of a child vehicle seat tether extension, also including a clip attached to one end of a strap having adjustment means for shortening, lengthening and tightening the strap, and a buckle having an opening attached to the other end of the strap;

FIG. 5 is a perspective view of one embodiment of a child vehicle seat tether extension, including a clip attached to both ends of a strap;

FIG. 6 is a perspective view of another embodiment of a child vehicle seat tether extension, including a clip attached to a rigid body member on a first end thereof, and a ring attached to the other end of the rigid body member;

FIG. 7 is a perspective view of another embodiment of a child vehicle seat tether extension, wherein the apparatus includes a rigid main body member, a clip on one end and a loop on the other end; and

FIG. 8 is a perspective view of another embodiment of a child vehicle seat tether extension, wherein the apparatus includes a rigid, extended main body member, a clip on one end and a loop on the other end.

### DETAILED DESCRIPTION OF THE INVENTION

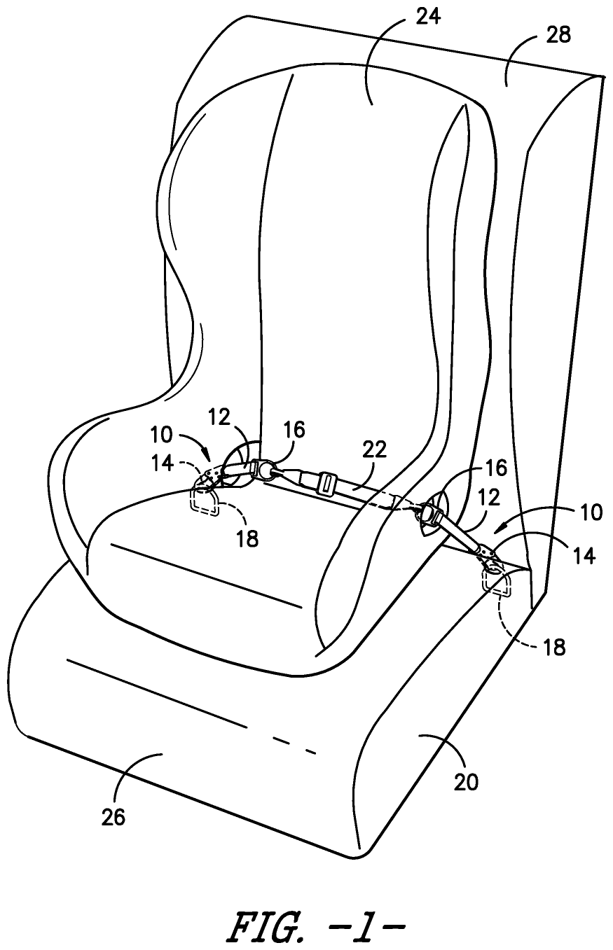

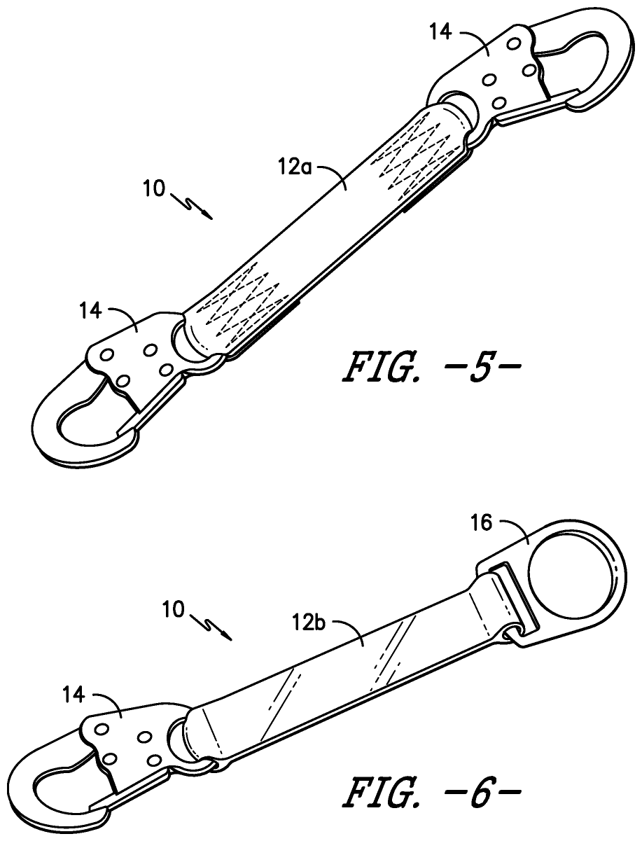

The present invention includes, in a first embodiment, a child safety seat tether extension apparatus 10 comprising a main body member 12 having attachment means 14 at each end thereof. In the first embodiment, the main body member 12 comprises a flexible strap. The attachment means is preferably a clip 14, as shown in FIG. 5, but it is contemplated that the attachment means on either end of the strap could be any suitable mechanism for attaching the tether extension apparatus to the anchor point 18 of a vehicle, such as a hook, carabiner, loop 16, ring, snap-fit mechanism, or the like, or a combination thereof, as shown in FIGS. 1-6.

The clip 14 on first end of the strap 12a attaches to an anchor point 18 in the seat 20 of a vehicle, and the clip 14 on the second end of the strap 12a attaches to the distal end of a tether 22 that is connected to the child safety seat 24. The strap 12a may be made of any suitable material, as long as it has the strength to maintain the child safety seat 24 securely in place, even in the event of an automobile accident. In a preferred embodiment, the strap 12a is made of nylon webbing, similarly to the strap material commonly used in automotive safety belts, but other types of material may be used.

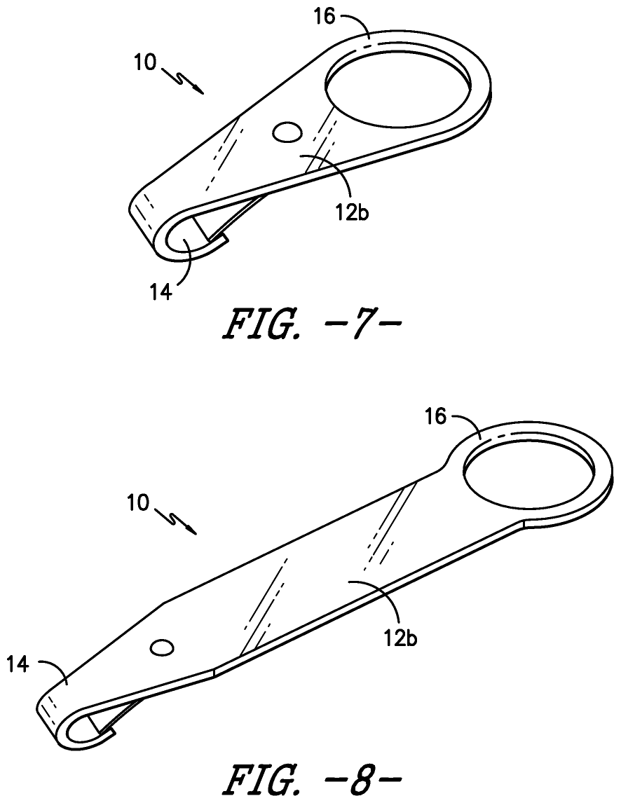

In an alternative embodiment, the tether extension apparatus 10 may include a generally rigid main body member 12b that is made from a rigid material, such as metal or plastic, as shown in FIGS. 6-8. The rigid tether extension apparatus 10 functions in a similar manner to the strap embodiment, which simply serves as a connector between the tether 22 of a child safety seat 24 (or may be attachable directly to the child safety seat 24) and the anchor point 18 disposed between the seat cushion 26 and the backrest 28 of an automobile or truck seat 20. FIG. 6 shows an embodiment in which the clip 14 and the loop 16 are pivotally attached to the main body member 12b, and FIGS. 7 and 8 depict an embodiment wherein the clip 14, the main body member 12b and the loop are rigid and are disposed in a fixed position relative to one another.

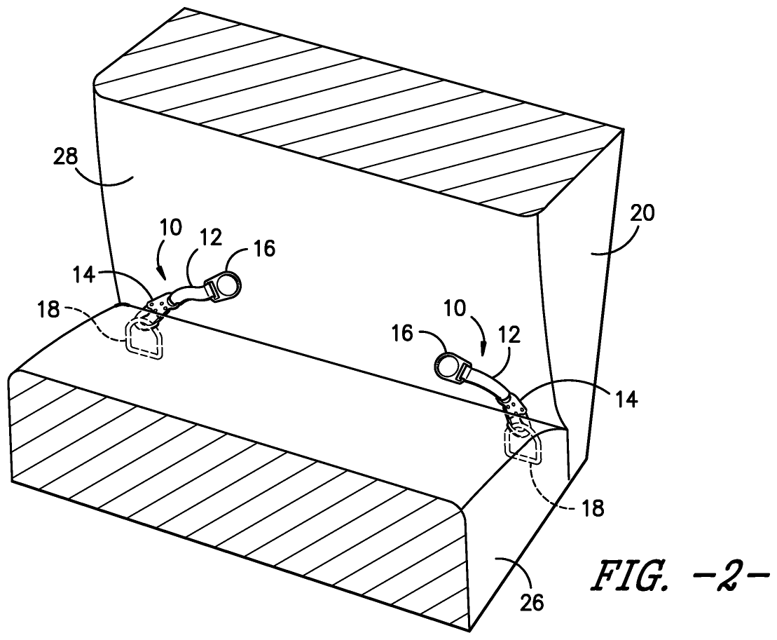

This arrangement allows a user to install the tether extension apparatus 10 by clipping the first end thereof to the anchor point 18 of the vehicle, and allowing the second end to extend outwardly from the seat crack between the seat cushion 26 and the backrest 28, so that the tether extension apparatus 10 is always visible and accessible to a user, as shown in FIG. 2. For families who own multiple vehicles, a tether extension apparatus 10 may be installed in each car, so that a user simply has to attach the car seat tether 22 to the clearly visible and easily accessible tether extension apparatus 10. This arrangement prevents a user from having to squeeze the child safety seat tether 22 between the seat crack, feeling around for the anchor point 18, and attaching the tether 22 to the anchor point 18 by sense of feel (as the anchor point 18 is typically not visible to a user during the installation process).

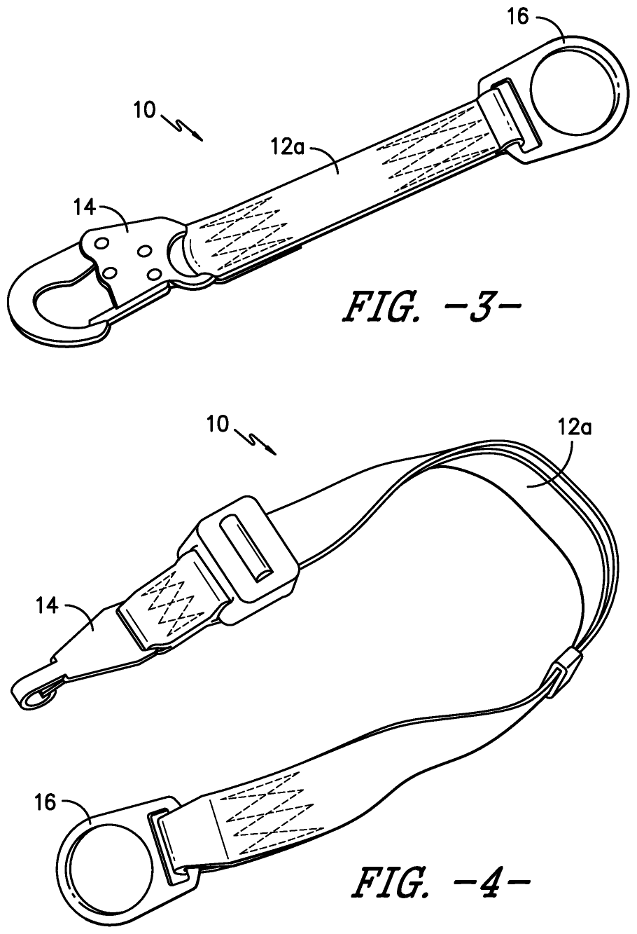

It is contemplated that both embodiments of the tether extension apparatus 10 (the strap embodiment and the rigid embodiment) may optionally include adjustment means 30 for adjusting the length thereof, as is well known in the art, and as shown in FIG. 4. For example, the strap 12a version may include an adjustable buckle 30 in order to adjust the length thereof, and the rigid tether extension apparatus may include adjustable means, as well, comprising two telescoping or sliding portions, for example, where one portion slides inwardly or outwardly with respect to the other portion. Further, both portions may be locked into place to achieve a desired length by using a securing means such as a spring loaded button and a series of holes that may be engaged by the spring loaded button. Other means for adjusting the length of the tether extension apparatus 10 may be used, and are well-known in the art.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A method for securing a child safety seat into a vehicle, comprising the steps of:
providing a tether extension member comprising a main body member having a first end and a second end;
providing attachment means on said first end;
providing attachment means on said second end;
attaching said first end to an anchor point in a vehicle; and
attaching said second end to a tether that is connected to a child safety, seat.

2. The method for securing a child safety seat into a vehicle as set forth in claim 1; wherein said main body member comprises a strap.

3. The method for securing a child safety seat into a vehicle as set forth in claim 1, wherein said main body member is made from a rigid material.

4. The method for securing a child safety seat into a vehicle as set forth in claim 1, wherein said attachment means is selected from the group consisting of a clip, a carabiner, and a hook.

5. The method for securing a child safety seat into a vehicle as set forth in claim 1, further comprising the step of adjusting a length of said main body member.

6. A method for securing a child safety seat into a vehicle, comprising the steps of:
providing a tether extension member comprising a main body member having a first end and a second end;
providing attachment means on said first end;
providing attachment means on said second end;
attaching said first end to an anchor point in a vehicle; and
attaching said second end to a child safety seat.

7. The method for securing a child safety seat into a vehicle as set forth in claim 6, wherein said main body member comprises a strap.

8. The method for securing a child safety seat into a vehicle as set forth in claim 6, wherein said main body member is made from a rigid material.

9. The method for securing a child safety seat into a vehicle as set forth in claim 6, wherein said attachment means is selected from the group consisting of a clip, a carabiner, and a hook.

10. The method for securing a child safety seat into a vehicle as set forth in claim 6, further comprising the step of adjusting a length of said main body member.

11. A tether extension apparatus for securing a child safety seat within a vehicle, said tether extension apparatus comprising:
a main body member having a first end and a second end;
said first end having an attachment means for attachment to an anchor point of a vehicle;
said second end having an attachment means for operative attachment to a child safety seat.

12. The tether extension apparatus set forth in claim 11, wherein said main body member comprises a strap.

13. The tether extension apparatus set forth in claim 11, wherein said main body member is made from a rigid material.

14. The tether extension apparatus set forth in claim 11, wherein said attachment means is selected from the group consisting of a clip, a carabiner, and a hook.

15. The tether extension apparatus set forth in claim 11, wherein a length of said main body member is adjustable.
